(19) United States
(12) Patent Application Publication
(10) Pub. No.: US 2005/0283378 A1
(43) Pub. Date: Dec. 22, 2005

(54) Asynchronous video interview system

(76) Inventor: Samuel Louis Iserson, Wilton, CT (US)

Correspondence Address: ST. ONGE STEWARD JOHNSTON & REENS, LLC, 986 BEDFORD STREET, STAMFORD, CT, 06905-5619, US

(21) Appl. No.: 11/212,981

(22) Filed: Aug. 26, 2005

Related U.S. Application Data
(63) Continuation of application No. 09/580,126, filed on May 30, 2000.

(51) Int. Cl. G06F 17/60

(52) U.S. Cl. 705/1

(57) ABSTRACT

A system for asynchronous video interviewing is provided. The system comprises a computer, storage device accessible by the computer, and software executing on the computer for forwarding interviewer video questions stored on the storage device to interviewees and for forwarding interviewees' video answers stored on the storage device to the interviewer. The system further provides remote access to interviewees for reviewing and answering the video questions and to the interviewer for reviewing video answers and selecting desired interviewees. The system further includes a camera for capturing the interviewees' video answers in real time for storage on the storage device.

This patent application is a continuation of currently pending U.S. patent application Ser. No. 09/580,126 filed May 30, 2000.

### BACKGROUND OF THE INVENTION

### FIELD OF THE INVENTION

The interview process has traditionally been a live, in-person dialogue between an interviewer and interviewee. Interviews are generally performed after the interviewer has had a chance to screen and reduce interviewees to a select number so that the interviewer can conduct as few interviews as possible in order to select the desired candidates. This process is desirable for the interviewer gets the opportunity to put a face with, in an interview for a job, the resume. As desirable as the process is, however, it is typically an unpleasant process for interviewers because the process is generally long, tedious, expensive, time consuming, and sometimes requires travel.

The interview process can generally be improved with video conferencing equipment. Video conferencing that allows a live, real time, face-to-face interview between remotely located parties may eliminate some of the disadvantages of interviewing such as travel, expense, and time consumption.

Interviews are generally associated with an applicant seeking a job and the interviewer is usually the employer who is evaluating his or her future employee. The interviewer may also be an intermediary who is interviewing applicants on behalf of an employer. These interviews may not necessarily be of applicants new to the employer but may be internally conducted where the applicants are current employees seeking a different position within an organization. However, interviews are not limited to the job seeking process but include, and is not limited to, colleges evaluating potential enrollees, the armed services seeking potential recruits, and adoption agencies seeking possible adoptive parents. As one can see, interviewing is a process that is a needed and desirable tool for many interviewers and this process is not limited to any economic or social class.

As a means to reduce the amount of interviewees, interviewers generally try to screen the candidates before hand so that the top choices are among those to be interviewed. For example, before a job interview, an employer typically reviews an applicant's resume and only after the applicant looks promising on paper will the applicant be asked for an interview. Having had a chance to meet the applicant, the interviewer usually has a better understanding of the type of person he or she may be working with and this allows the interviewer to make an informed decision. As beneficial as the interviewing process is, interviewers typically find it to be unpleasant for a variety of reasons.

One disadvantage to the interviewing process is that it is normally time consuming, especially if travel is required. For example, college and career fairs are held throughout the country and many colleges and/or institutions from around the nation send representatives to provide information about their respective organizations and to recruit potential applicants. Further, colleges and institutions may also conduct interviews at these fairs upon seeing promising candidates. These fairs can easily run for several days and can take representatives away from their families.

Another disadvantage to the interviewing process is that it is characteristically expensive. In addition to food and lodging expenses to representatives who travel on behalf of the institution, representatives cannot work and generate revenue during the process. In a situation where the applicant comes to the interviewer's location, similar expenses are realized for the interviewer normally reimburses the applicant for any out of pocket expenses.

A still further disadvantage is that the interviewing process cannot be expedited. The questions need to be asked and answered and getting to know an applicant's personality traits generally cannot be done hastily. Therefore, to interviewers, the process may be long and tedious and at times can be unpleasant despite the overall benefits.

Yet another disadvantage to the interviewing process is that interviewers cannot interview everyone and may sometimes exclude promising applicants from the interviewing process simply because of time restraints. This would be undesirable for the interviewer, who must screen the hundreds of applicants by their resumes, would have passed over a qualified candidate.

Yet another disadvantage to the interviewing process is that there may be differences in the way interviews are conducted throughout the day and these differences may hinder interviewers from making an objective decision. For example, interviewers may get tired as the day goes on and may ask different questions to different interviewees. Or the interviewers may ask the same questions but in a different tone or with different body language that could influence an interviewee's answers. Hence, these variants may affect the way interviewers objectively evaluate interviewees.

What is desired, therefore, is to provide a system that allows interviewers to distribute information about their institution to potential applicants. Another desire is to provide a system for allowing interviewers to evaluate interviewees from a remote location. What is also desired is to provide a system of screening potential applicants beyond the resume stage but before, or possibly replace, the live, in-person interviewing process. It is still further desired to provide a system that allows an interviewer to interview a wider range of applicants in a shorter period of time than live, in-person interviews permit. Yet, it is further desired to provide a system that allows interviewers to pause the evaluating process until there is a more convenient time for the interviewer. What is still further desired is to provide a system that allows interviewers to pose questions consistently in the same manner among various interviewees so as to facilitate objective evaluations.

### SUMMARY OF THE INVENTION

Accordingly, it is an object of the invention to provide a system for asynchronously recording video and audio data in the form of questions and answers between interviewers and interviewees, respectively, both of whom may be remotely located from one another.

Another object is to provide a system for allowing interviewers to distribute information by recording visual and audio data onto a storage device.

Another object is to provide a system for allowing remotely located interviewees access to the storage device to receive the interviewers' visual and audio data.

A further object is to provide a system for allowing remotely located interviewees to respond to the interviewers' visual and audio data.

A further object is to provide a system for recording interviewees' responses in the form of video and audio data.

Yet another object is to provide a system for providing interviewers with remotely located interviewees' visual and audio data.

Yet another object is to provide a system for allowing interviewers to evaluate interviewees from a remote location.

Still a further object is to provide a system for allowing interviewers to ask questions that interviewees may answer at a different time.

Still a further object is to provide a system for allowing an interviewer to interview a wider range of applicants in a shorter period of time than live, in-person interviews permit.

Still another object is to provide a system for allowing interviewers to pause the evaluating process until a more convenient time.

Still another object is to provide a system for allowing interviewers to pose questions consistently in the same manner to various interviewees so as to facilitate objective evaluations.

These and other objects of the invention are achieved by a computer program that records and stores textual, image, and audio data from an interviewer onto a storage device that is accessible to potential interviewees. The interviewees may be remotely located from the interviewer but will be able to asynchronously access the storage device to review and respond to the interviewer's textual, image, and audio data. When responding, the interviewees' image and audio data will be recorded and stored by the program onto the storage device for later evaluation by the interviewer.

### BRIEF DESCRIPTION OF THE DRAWINGS

FIG. 1 is a schematic block diagram of a system for video interviewing in accordance with the invention.

FIG. 2 is a schematic block diagram illustrating the system forwarding interviewee answers to a third party.

FIG. 3 is a schematic block diagram illustrating the system matching interviewer requirements with qualified interviewees

FIG. 4 is is a schematic block diagram illustrating interviewees remotely accessing the system.

### DETAILED DESCRIPTION OF THE DRAWINGS

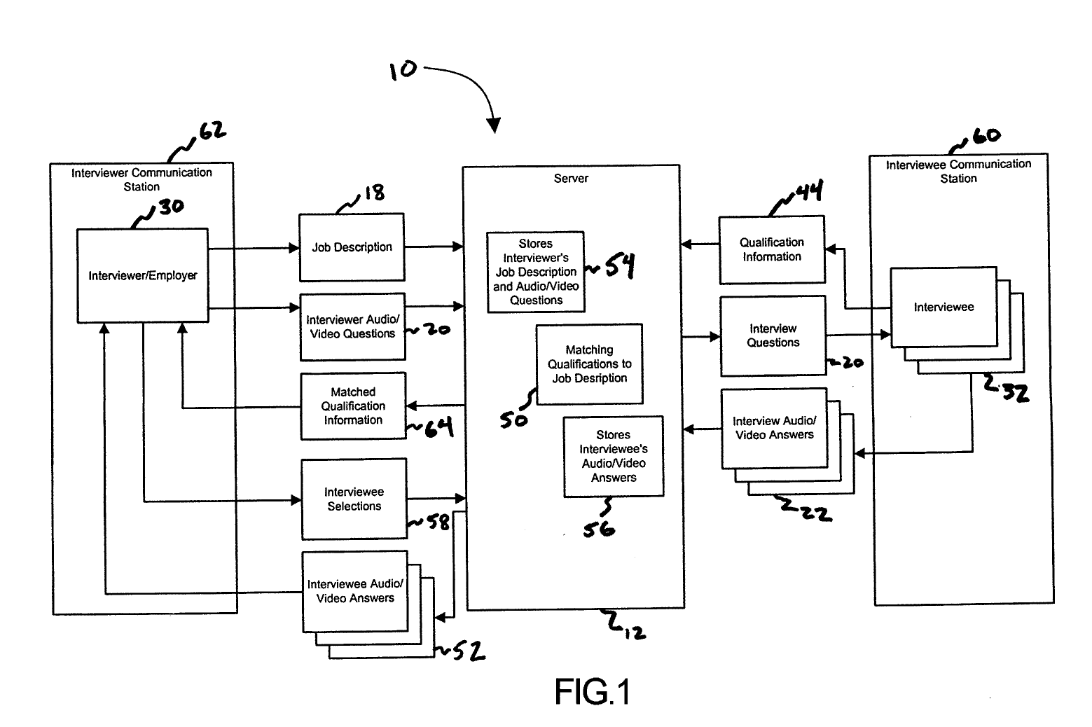

FIG. 1 depicts a system 10 for video interviewing in accordance with the invention. System 10 stores 54 an interviewer's questions 20 on a storage device 12, which is accessible by a computer. Interviewees 32 may thereafter review questions 20 and submit answers 22 to corresponding questions 20 for storage on storage device 12. A camera captures interviewees' answers 22 in real time. Further, system 10 matches 50 interviewees' answers 22 with interviewer's 30 job requirements 18 and asynchronously forward 52 answers 22 to interviewer 30.

System 10 stores 54 an interviewer's job requirements 18 and questions 20 on storage device 12. Both job requirements 18 and questions 20 comprise textual, video, and/or audio data, or a combination or subcombination of said textual, video, and/or audio data. System 10 stores on storage device 12 questions 20 from one or more interviewing personnel, whereby the personnel may be from different entities.

Job requirements 18 comprise an advertisement of a job and its duties along with requirements interviewer 30 may desire potential applicants to have. Job requirements 18 may further include any other information interviewer 30 chooses to impart such as a description of the company and the company's history or product/services in which it is engaged.

In instances where the interview process is for college recruiting, job requirements 18 may include a description of the college and the college's history and may further include statistics of an entering class' grade point average or test scores. Job requirements 18 may also include a description of a college's curriculum or courses offered and other information such as the college's requirements for admittance.

Questions 20 comprise an interviewer's questions to be answered by interviewees, whereby questions 20 are stored on storage device 12. Interviewer 30 may ask questions 20 all at once or at different times. Further, interviewer 30 may comprise of persons from different entities such as a collection of companies or colleges joining together in seeking common applicants. Therefore, system 10 allows interviewer 30 to be able to store questions 20 on storage device 12 at varying times. Further, system 10 permits interviewer 30 to ask questions 20 from any location accessible to storage device, including a remote location such as an Internet location.

System 10 allows interviewees 32 access to questions 20. Interviewees' communication station 60 includes a monitor, whereby interviewer's questions 20 are displayed thereon for review by interviewees 32. Interviewees then provide answers 22 to corresponding questions 20 and a camera, also located at interviewees' communication station 60, captures and stores 56 interviewees' answers 22 in real time on storage device 12.

System 10 may further provide remote access to interviewees 32 so long as interviewees 32 are using a communication station accessible to storage device 12. For example, interviewee's 32 may access questions 20 using a computer from a remotely located Internet location and having access to a storage device, such as a web based server. In addition, the camera may also be remotely located so that interviewee's answers 22 are captured in real time. As the camera captures interviewees' answers 22, system 10 saves 56 answers 22 onto storage device 12.

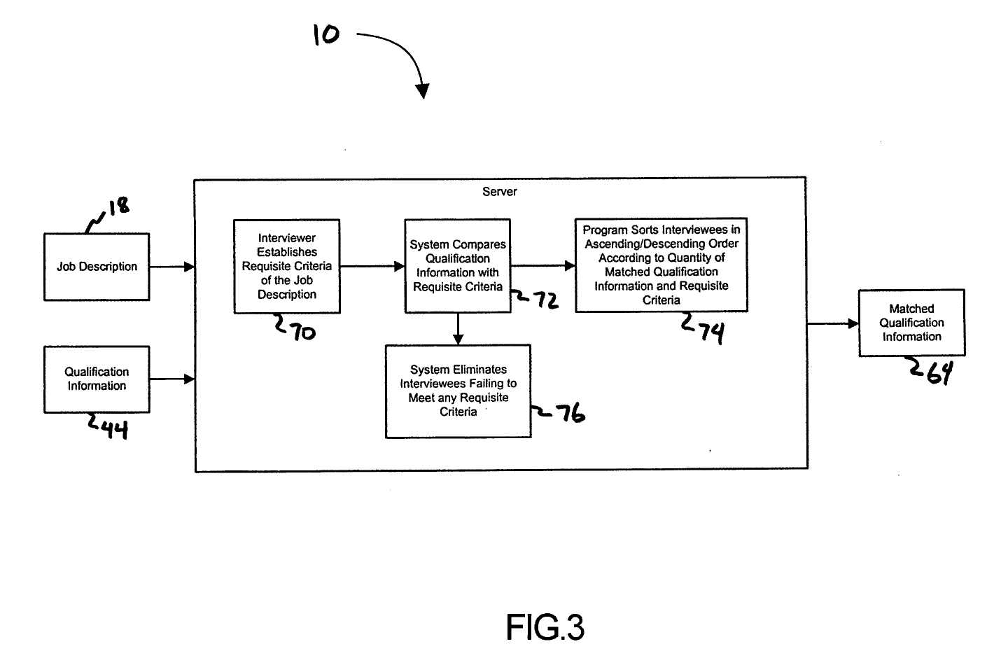

System 10 may, in an effort to reduce the number of interviews an interviewer must review, eliminate unqualified interviewees 32 from the interviewing process. This may be where system 10 matches 50 qualification information 44 to job requirements 18. System 10 may further match 50 questions 20 to answers 22. How system 10 matches interviewees with interviewer's requirements is more particularly depicted in FIG. 3.

System 10 further allows interviewer 30 to asynchronously review answers 22. In other words, interviewer 30 may review interviewees' 32 answers 22 at a different time from when they were given and stored on storage device 12. In addition, system 10 may permit interviewer 30 the ability to download or copy answers 22 to another storage medium, such as a floppy disk, internal tape drive, external tape drive, or other portable or non-portable storage medium, and review answers 22 later from a location whereby interviewer 30 does not have access to storage device 12.

After answers 22 have been captured by the camera and stored 56 on storage device 12, interviewer 30 may, at any time, access storage device 12 and review answers 22. Interviewer 30 may review answers 22 from a communication station 62 that is accessible to storage device 12. Further, interviewer 30 may remotely access and review answers 22 stored on storage device 12, such as from a computer in a remote location, including an Internet location.

Upon accessing answers 22, interviewer 30 may review answers 22 all at once or pause reviewing interviewees' answers 22. Similar to the way a video cassette recorder plays video cassettes, system 10 permits interviewer 30 the capability to play, stop, pause, or replay any portion of interviewees' answers 22. Further, system 10 permits interviewer 30 the ability to skip or fast forward through answers 22.

To ensure that only interviewer 30 has access to answers 22, answers 22 may be encrypted and only a user with a password is given access to answers 22. Interviewer 30 is privy to such a password.

After Interviewers 30 have reviewed answers 22 or have decided to further narrow the quantity of interviewees, system 10 permits interviewer 30 to be able to select 58 which interviewee or interviewees they desire and system 10 subsequently sends rejection letters to the remainder of interviewees, non-selected interviewees, and acceptance letters to successful candidates.

Interviewer 30 may select 58 desired interviewees by merely clicking on an interviewee's name or by performing other simple keystrokes. To prevent an incorrect selection, system 10 may require more purposeful and complicated keystrokes by interviewer 30, such as requiring interviewer 30 to retype his password or type out the names of selected interviewees.

Hence, system 10 provides interviewer 30 and interviewees 32 the ability to conduct an interview in real time from remote locations and system 10 further provides the ability to asynchronously conduct the interview.

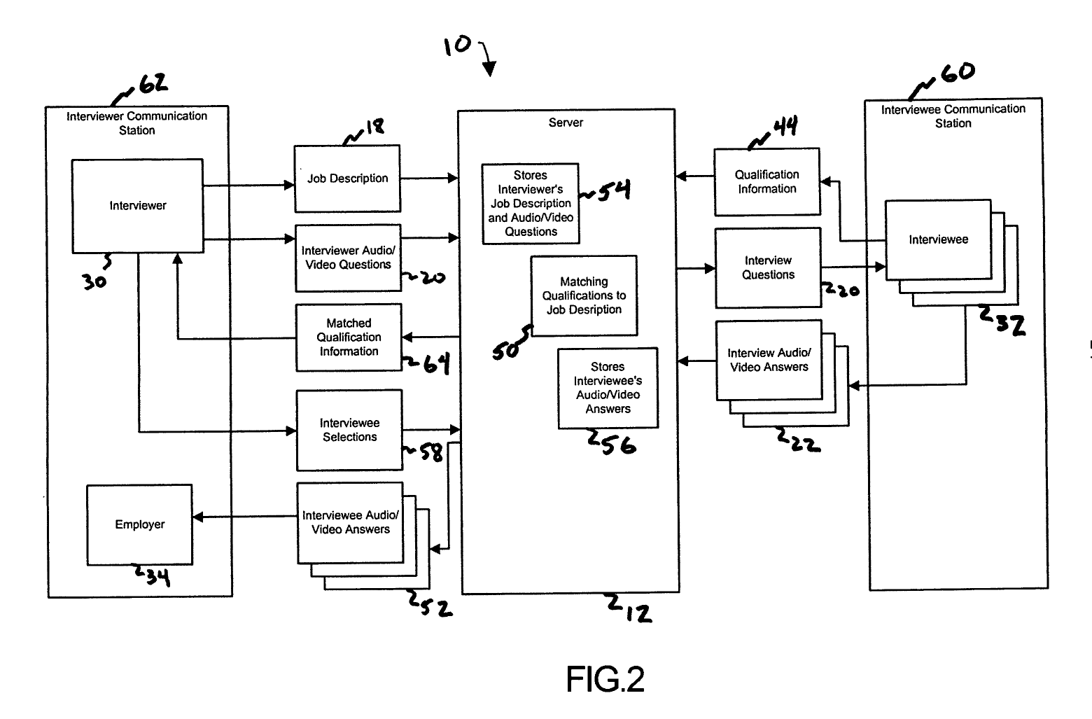

FIG. 2 depicts system 10 forwarding 52 answers 22 to a third party 34. Once interviewer 30 has selected desired interviewees, system 10 provides interviewer 30 with the ability to send 52 answers 22, of selected as well as non-selected interviewees, to third party 34. This permits third party 34 with the ability to oversee the interviewer's selection from the original amount of interviewees and the ability to reverse the interviewer's selection and make an alternative selection. Third party 34 may be the employer who hired interviewer 30 to search for and screen potential interviewees. When interviewer 30 has interviewed and selected a number of interviewees based upon interviewees' answers 22, interviewer 30 may then have system 10 send the results to third party 34.

FIG. 3 depicts system 10 matching interviewees with an interviewer's requirements. To reduce the number of interviews an interviewer must review and eliminate unqualified interviewees 32 from the interviewing process, system 10 matches qualification information 44 to job requirements 18. In a further aspect, system 10 may match questions 20 to answers 22.

Qualification information 44 comprises textual, video, and/or audio data, or a combination or subcombination of said textual, video, and/or audio data. Qualification information 44 may include information potential applicants submitted in response to information disclosed in interviewer's 30 job requirements 18 but prior to interviewees being able to review questions 20 or submit answers 22. System 10 matches qualification information 44 with job requirements 18 and eliminate 76 applicants who do not meet requisite criteria disclosed in job requirements 18. For applicants meeting the requisite criteria, system 10 sorts applicants in ascending/descending order according to the number of matches between job requirements 18 and qualification information 44.

Interviewer 30 may need to designate 70 requisite criteria for system 10 to use as a model for qualification information to meet. System 10 then compares 72 qualification information 44 to the requisite criteria and eliminates 76 applicants not having any matches. For applicants having at least one match, system 10 sorts 74 applicants in ascending/descending order according to the quantity of matches, thereby providing matched qualification information 64.

System 10 permits applicants having matched qualification information 64 to review and answer interviewer's questions 20 and submit answers 22. This may be accomplished by sending interviewees a user name and password in order to access questions 20.

In another aspect, system 10 may eliminate unqualified interviewees by matching questions 20 with answers 22. System 10 permits all applicants access to questions 20 and stores all answers 22 on storage device 12. System 10 thereafter determines whether answers 22 match job requirements 18 and/or desired answers, provided by interviewer 30, to questions 20.

In both aspects where system 10 eliminates unqualified interviewees from the interviewing process, the number of interviews to be reviewed by interviewer 30 has been reduced. Hence, system 10 has matched interviewees 32 with requirements that interviewer 30 has chosen to be necessary or desired in order to provide a smaller, but more qualified, pool of interviewees 32 from which interviewer 30 may select. In essence, system 10 has screened out those that interviewer 30 would have readily deemed unqualified.

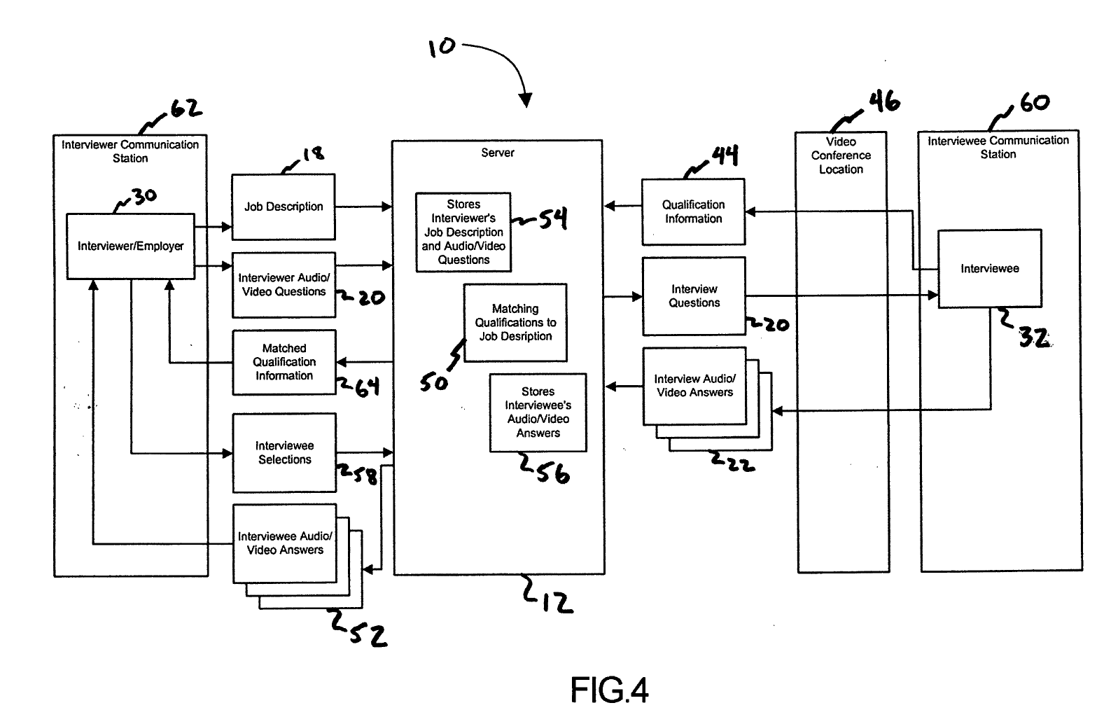

FIG. 4 more particularly depicts how interviewee 32 may, but need not, submit qualification information 44, review questions 20, and submit answers 22 to system 10 from a remote location, or video conference location 46. In essence, interviewer 30 may remotely conduct an interview with interviewee 32.

System 10 allows interviewee 32 to submit qualification information 44 in response to job description 18. Thereafter, interviewee 32 is able to review questions 20 and provide answers 22 to them. The camera, also remotely located in video conference location 46, captures answers 22 in real time and stores them correspondingly with questions 20 in storage device 12.

1. A system for video interviewing, comprising:
a computer;
a storage device accessible by said computer;
interviewer's question video data stored on storage device;
remote electronic access to said computer by at least one interviewee to review said interviewer's question video data;
software executing on said computer for forwarding said interviewer's question video data to said at least one interviewee;
a camera for capturing at least one interviewee's answer video data to said interviewer's question video data in real time for storage on said storage device together with corresponding interviewer's question video data; and
said software executing on said computer for forwarding said at least one interviewee's answer video data to an interviewer.

2. The system according to claim 1, wherein said software adjusts a time period during which said camera captures said at least one interviewee's answer video data.

3. The system according to claim 1, wherein said software executing on said computer matches said at least one interviewee's answer video data with said interviewer question video data.

4. The system according to claim 1, wherein said camera simultaneously captures said at least one interviewee's and at least a second interviewee's answer video data.

5. The system according to claim 1, wherein said software executing on said computer simultaneously forwards at least one interviewee's and at least a second interviewee's answer video data to said interviewer.

6. The system according to claim 1, wherein said software executing on said computer allows said interviewer to select among said at least one interviewee and at least a second interviewee.

7. The system according to claim 1, wherein said software executing on said computer sends said at least one interviewee's answer video data to a third party.

8. The system according to claim 1, wherein said system forwards said at least one interviewee's answer video data to said interviewer at a time different from when said at least one interviewee's answer video data was stored on said storage device.

9. The system according to claim 1, wherein said software allows said interviewer to copy said at least one interviewee's answer video data onto a storage medium.

10. The system according to claim 9, wherein said storage medium is located remotely from said storage device.

11. A method for video interviewing, comprising:
loading software on a computer for storing and retrieving an interviewer's question video data on a storage device accessible by said computer;
accessing said computer from a remote location;
forwarding said interviewer's question video data to at least one interviewee for review;
capturing on a camera at least one interviewee's answer video data to said interviewer's question video data in real time;
storing said interviewee's answer video data on said storage device together with corresponding interviewer's question video data; and
forwarding said at least one interviewee's answer video data to an interviewer.

12. The method according to claim 11 further comprising the step of adjusting a time period for capturing on said camera said at least one interviewee's answer video data.

13. The method according to claim 11 further comprising the step of matching said at least interviewee's answer video data with said interviewer's question video data.

14. The method according to claim 11 further comprising the step of forwarding said at least one interviewee's answer video data to a third party.

15. The method according to claim 11 further comprising the step of forwarding said at least one interviewee's answer video data to said interviewer at a time different from when said at least one interviewee's answer video data was stored on said storage device.
